(19) United States
(12) Patent Application Publication
(10) Pub. No.: US 2024/0244722 A1
(43) Pub. Date: Jul. 18, 2024

(54) HEATING STRUCTURE AND AEROSOL GENERATING DEVICE AND SYSTEM INCLUDING THE SAME

(71) Applicant: KT & G CORPORATION, Daejeon (KR)

(72) Inventors: Dong Sung KIM, Seoul (KR); Youngbum KWON, Yongin-si (KR); Yong Hwan KIM, Anyang-si (KR); Hunil LIM, Seoul (KR); Seok Su JANG, Daejeon (KR)

(73) Assignee: KT&G CORPORATION, Daejeon (KR)

(21) Appl. No.: 18/290,253

(22) PCT Filed: Apr. 7, 2023
(86) PCT No.: PCT/KR2023/004688

§ 371 Date: Nov. 10, 2023

(30) Foreign Application Priority Data
Apr. 18, 2022 (KR) 10-2022-0047481

(51) Int. Cl. H05B 6/44; A24F 40/20; A24F 40/465; H05B 6/10

(52) U.S. Cl. CPC H05B 6/44; A24F 40/20; A24F 40/465; H05B 6/105

(57) ABSTRACT

A heating structure includes a heating housing including a body portion, the body portion including a first surface, a second surface opposite to the first surface, and a side surface between the first surface and the second surface, and a hollow portion defined by the side surface, a first coil having a first axis in a first direction between the first surface and the second surface of the body portion, and a second coil having a second axis in a second direction intersecting with the first direction of the body portion.

### TECHNICAL FIELD

The disclosure relates to a heating structure and an aerosol generating device and a system including the same.

### BACKGROUND ART

Techniques for introducing airflows into an aerosol generating article are being developed to provide atomization performance. For example, aerosol generating devices that generate an aerosol from an aerosol generating article in a non-burning manner are being developed. The above description is information the inventor(s) acquired during the course of conceiving the disclosure, or already possessed at the time, and is not necessarily art publicly known before the present application was filed.

### DISCLOSURE OF THE INVENTION

### Technical Problem

An aspect of the disclosure may provide a heating structure that improves heating efficiency of an aerosol generating article and an aerosol generating device including the same.

### Solution to Problem

A heating structure may include a heating housing including a body portion, the body portion including a first surface, a second surface opposite to the first surface, and a side surface between the first surface and the second surface, and a hollow portion defined by the side surface, a first coil having a first axis in a first direction between the first surface and the second surface, and a second coil having a second axis in a second direction intersecting with the first direction of the body portion.

The first direction may be a longitudinal direction from the second surface to the first surface, and the second direction may be a normal direction of the side surface of the body portion.

The first coil may be wound in a clockwise direction on the first axis, and the second coil may be wound in a clockwise direction on the second axis.

The first coil and the second coil may be directly connected on the side surface of the body portion.

The first coil and the second coil may be separated on the side surface of the body portion.

The first coil may be positioned in a first region of the body portion, and the second coil may be positioned in a second region different from the first region of the body portion.

The first region may be a region adjacent to the first surface, and the second region is a region adjacent to the second surface.

The heating structure may further include a third coil having a third axis in a third direction intersecting with each of the first direction and the second direction of the body portion.

The third direction may be a normal direction of the side surface of the body portion.

The third coil may be wound in a clockwise direction on the third axis.

An aerosol generating device may include a housing configured to accommodate an aerosol generating article and a heating structure configured to heat the aerosol generating article positioned and accommodated in the housing, wherein the heating structure may include a heating housing including a body portion, the body portion including a first surface, a second surface opposite to the first surface, and a side surface between the first surface and the second surface, and a hollow portion defined by the side surface, a first coil having a first axis in a first direction between the first surface and the second surface, and a second coil having a second axis in a second direction intersecting with the first direction of the body portion.

The first coil and the second coil may be directly connected on the side surface of the body portion.

The first coil and the second coil may be separated on the side surface of the body portion.

The heating structure may further include a third coil having a third axis in a third direction intersecting with each of the first direction and the second direction of the body portion.

An aerosol generating system may include an aerosol generating article including an aerosol generating material and a susceptor, a housing configured to accommodate the aerosol generating article, and a heating structure configured to heat the aerosol generating article positioned and accommodated in the housing, wherein the heating structure may include a heating housing including a body portion, the body portion including a first surface, a second surface opposite to the first surface, and a side surface between the first surface and the second surface, and a hollow portion defined by the side surface, a first coil having a first axis in a first direction between the first surface and the second surface of the body portion, and a second coil having a second axis in a second direction intersecting with the first direction of the body portion.

### Advantageous Effects of Invention

According to an embodiment, an aerosol generating article may be heated uniformly in various directions. According to an embodiment, an aerosol generating article that fits in a heating structure may be manufactured. The effects of a heating structure and an aerosol generating device and a system including the same according to an embodiment may not be limited to the above-mentioned effects, and other unmentioned effects may be clearly understood from the following description by one of ordinary skill in the art.

### BRIEF DESCRIPTION OF DRAWINGS

The foregoing and other aspects, features, and advantages of embodiments in the disclosure will become apparent from the following detailed description with reference to the accompanying drawings.

FIGS. 1 to 3 are diagrams illustrating examples of an aerosol generating article (e.g., a cigarette) inserted into an aerosol generating device according to an embodiment.

FIGS. 4 and 5 are diagrams illustrating examples of an aerosol generating article (e.g., a cigarette) according to an embodiment.

FIG. 6 is a block diagram of an aerosol generating device according to an embodiment.

FIG. 7 is a perspective view of a heating structure for heating an aerosol generating article according to an embodiment.

FIG. 8 is a side view of a heating structure according to an embodiment.

FIG. 9 is a cross-sectional view of a heating structure according to an embodiment.

### MODE FOR THE INVENTION

The terms used to describe the embodiments are selected from among common terms that are currently widely used, in consideration of their function in the disclosure. However, different terms may be used depending on an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used to describe the disclosure should be defined based on the meanings of the terms and all the content of the disclosure, rather than the terms themselves.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and which may be implemented as hardware, software, or a combination of hardware and software.

Hereinbelow, embodiments of the disclosure will be described in detail with reference to the accompanying drawings so that the embodiments may be readily implemented by one of ordinary skill in the art to which the disclosure pertains. However, the disclosure may be implemented in many different forms and is not limited to the embodiments described herein.

Hereinafter, embodiments of the disclosure will be described in detail with reference to the drawings.

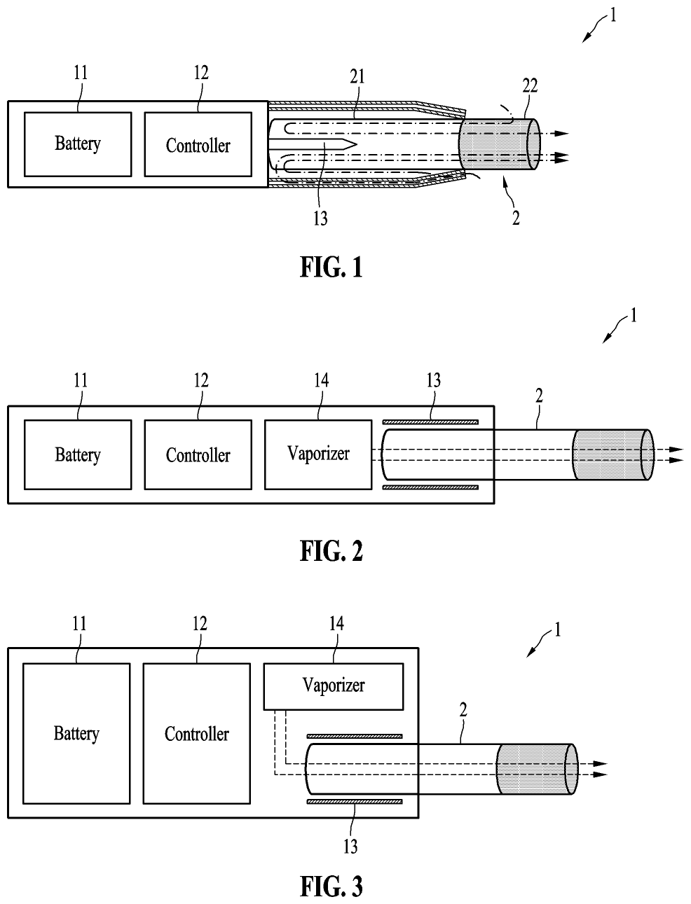

FIGS. 1 to 3 are diagrams illustrating examples of a cigarette inserted into an aerosol generating device.

Referring to FIG. 1, an aerosol generating device 1 may include a battery 11, a controller 12, and a heater 13. Referring to FIGS. 2 and 3, the aerosol generating device 1 may further include a vaporizer 14. A cigarette 2 may be inserted into an inner space of the aerosol generating device 1.

The aerosol generating device 1 shown in FIGS. 1 to 3 may include components related to the embodiments described herein. Therefore, it is to be understood by one of ordinary skill in the art to which the disclosure pertains that the aerosol generating device 1 may further include other general-purpose components in addition to the ones shown in FIGS. 1 to 3.

In addition, although it is shown that the heater 13 is included in the aerosol generating device 1 in FIGS. 2 and 3, the heater 13 may be omitted as needed.

FIG. 1 illustrates a linear alignment of the battery 11, the controller 12, and the heater 13. FIG. 2 illustrates a linear alignment of the battery 11, the controller 12, the vaporizer 14, and the heater 13. FIG. 3 illustrates a parallel alignment of the vaporizer 14 and the heater 13. However, the internal structure of the aerosol generating device 1 is not limited to what is shown in FIGS. 1 to 3. That is, the alignments of the battery 11, the controller 12, the heater 13, and the vaporizer 14 may be changed depending on the design of the aerosol generating device 1.

When the cigarette 2 is inserted into the aerosol generating device 1, the aerosol generating device 1 may operate the heater 13 and/or the vaporizer 14 to generate an aerosol. The aerosol generated by the heater 13 and/or the vaporizer 14 may pass through the cigarette 2 into the user.

Even when the cigarette 2 is not inserted into the aerosol generating device 1, the aerosol generating device 1 may heat the heater 13, as needed.

The battery 11 may supply power to be used to operate the aerosol generating device 1. For example, the battery 11 may supply power to heat the heater 13 or the vaporizer 14, and may supply power required for the controller 12 to operate. In addition, the battery 11 may supply power required to operate a display, a sensor, a motor, or the like installed in the aerosol generating device 1.

The controller 12 may control the overall operation of the aerosol generating device 1. Specifically, the controller 12 may control respective operations of other components included in the aerosol generating device 1, in addition to the battery 11, the heater 13, and the vaporizer 14. In addition, the controller 12 may verify a state of each of the components of the aerosol generating device 1 to determine whether the aerosol generating device 1 is in an operable state.

The controller 12 may include at least one processor. The processor may be implemented as an array of a plurality of logic gates, or may be implemented as a combination of a general-purpose microprocessor and a memory in which a program executable in the microprocessor is stored. In addition, it is to be understood by one of ordinary skill in the art to which the disclosure pertains that the processor may be implemented in other types of hardware.

The heater 13 may be heated by power supplied by the battery 11. For example, when a cigarette is inserted into the aerosol generating device 1, the heater 13 may be disposed outside the cigarette. The heated heater 13 may thus raise the temperature of an aerosol generating material in the cigarette.

The heater 13 may be an electrically resistive heater. For example, the heater 13 may include an electrically conductive track, and the heater 13 may be heated as a current flows through the electrically conductive track. However, the heater 13 is not limited to the foregoing example, and any example of heating the heater 13 up to a desired temperature may be applicable without limitation. Here, the desired temperature may be preset in the aerosol generating device 1 or may be set by the user.

As another example, the heater 13 may be an induction heater. Specifically, the heater 13 may include an electrically conductive coil for heating the cigarette in an induction heating manner, and the cigarette may include a susceptor to be heated by the induction heater.

For example, the heater 13 may include a tubular heating element, a plate-shaped heating element, a needle-shaped heating element, or a rod-shaped heating element, and may heat the inside or outside of the cigarette 2 according to the shape of a heating element.

In addition, the heater 13 may be provided as a plurality of heaters in the aerosol generating device 1. In this case, the plurality of heaters 13 may be disposed to be inserted into the cigarette 2, or may be disposed outside the cigarette 2. In addition, some of the heaters 13 may be disposed to be inserted into the cigarette 2, and the rest may be disposed outside the cigarette 2. However, the shape of the heater 13 is not limited to what is shown in FIGS. 1 to 3 but may be provided in various shapes.

The vaporizer 14 may heat a liquid composition to generate an aerosol, and the generated aerosol may pass through the cigarette 2 into the user. That is, the aerosol generated by the vaporizer 14 may travel along an airflow path of the aerosol generating device 1, and the airflow path may be configured such that the aerosol generated by the vaporizer 14 may pass through the cigarette into the user.

For example, the vaporizer 14 may include a liquid storage, a liquid transfer means, and a heating element. However, embodiments are not limited thereto. For example, the liquid storage, the liquid transfer means, and the heating element may be included as independent modules in the aerosol generating device 1.

The liquid storage may store the liquid composition. For example, the liquid composition may be a liquid including a tobacco-containing material having a volatile tobacco flavor ingredient or a liquid including a non-tobacco material. The liquid storage may be manufactured to be detachable and attachable from and to the vaporizer 14, or may be manufactured in an integral form with the vaporizer 14.

The liquid composition may include, for example, water, a solvent, ethanol, a plant extract, a fragrance, a flavoring agent, or a vitamin mixture. The fragrance may include, for example, menthol, peppermint, spearmint oil, various fruit-flavored ingredients, and the like. However, embodiments are not limited thereto. The flavoring agent may include ingredients that provide the user with a variety of flavors or scents. The vitamin mixture may be a mixture of at least one of vitamin A, vitamin B, vitamin C, or vitamin E, but is not limited thereto. The liquid composition may also include an aerosol former such as glycerin and propylene glycol.

The liquid transfer means may transfer the liquid composition in the liquid storage to the heating element. The liquid transfer means may be, for example, a wick such as cotton fiber, ceramic fiber, glass fiber, or porous ceramic. However, embodiments are not limited thereto.

The heating element may be an element configured to heat the liquid composition transferred by the liquid transfer means. The heating element may be, for example, a metal heating wire, a metal heating plate, a ceramic heater, or the like. However, embodiments are not limited thereto. In addition, the heating element may include a conductive filament such as a nichrome wire, and may be arranged in a structure wound around the liquid transfer means. The heating element may be heated as a current is supplied and may transfer heat to the liquid composition in contact with the heating element, and may thereby heat the liquid composition. As a result, an aerosol may be generated.

For example, the vaporizer 14 may also be referred to as a cartomizer or an atomizer. However, embodiments are not limited thereto.

The aerosol generating device 1 may further include general-purpose components in addition to the battery 11, the controller 12, the heater 13, and the vaporizer 14. For example, the aerosol generating device 1 may include a display that outputs visual information and/or a motor that outputs tactile information. In addition, the aerosol generating device 1 may include at least one sensor (e.g., a puff sensor, a temperature sensor, an insertion detection sensor for an aerosol generating article, etc.). In addition, the aerosol generating device 1 may be manufactured to have a structure in which external air may be introduced or internal gas may flow out even with the cigarette 2 being inserted.

Although not shown in FIGS. 1 to 3, the aerosol generating device 1 may constitute a system along with a separate cradle. For example, the cradle may be used to charge the battery 11 of the aerosol generating device 1. Alternatively, the cradle may be used to heat the heater 13, with the cradle and the aerosol generating device 1 coupled.

The cigarette 2 may be of a similar type to a general burning type. For example, the cigarette 2 may be divided into a first portion including an aerosol generating material and a second portion including a filter or the like. Alternatively, the second portion of the cigarette 2 may also include the aerosol generating material. For example, the aerosol generating material provided in the form of granules or capsules may be inserted into the second portion.

The first portion may be entirely inserted into the aerosol generating device 1 and the second portion may be exposed outside. Alternatively, only the first portion may be partially inserted into the aerosol generating device 1, or the first portion may be entirely inserted into the aerosol generating device 1 and the second portion may be partially inserted into the aerosol generating device 1. The user may inhale the aerosol with the second portion in a mouth of the user. In this case, the aerosol may be generated as external air passes through the first portion, and the generated aerosol may pass through the second portion into the mouth of the user.

For example, the external air may be introduced through at least one air path formed in the aerosol generating device 1. In this example, opening or closing and/or the size of the air path formed in the aerosol generating device 1 may be adjusted by the user. Accordingly, an amount of atomization, a sense of smoking, or the like may be adjusted by the user. As another example, the external air may be introduced into the inside of the cigarette 2 through at least one hole formed on a surface of the cigarette 2.

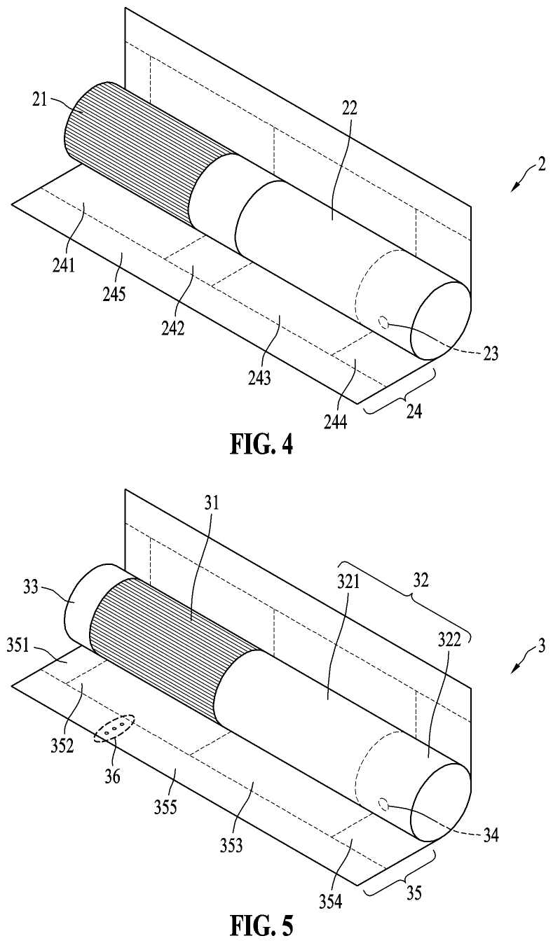

Hereinafter, examples of the cigarette 2 will be described with reference to FIGS. 4 and 5.

FIGS. 4 and 5 are diagrams illustrating examples of a cigarette according to an embodiment.

Referring to FIG. 4, the cigarette 2 may include a tobacco rod 21 and a filter rod 22. The first portion and the second portion described above with reference to FIGS. 1 to 3 may include the tobacco rod 21 and the filter rod 22, respectively.

Although the filter rod 22 is illustrated as having a single segment in FIG. 4, embodiments are not limited thereto. That is, alternatively, the filter rod 22 may include a plurality of segments. For example, the filter rod 22 may include a segment that cools an aerosol and a segment that filters a predetermined ingredient contained in an aerosol. In addition, the filter rod 22 may further include at least one segment that performs another function as needed.

A diameter of the cigarette 2 may be in a range of 5 millimeters (mm) to 9 mm, and the length thereof may be about 48 mm. However, embodiments are not limited thereto. For example, a length of the tobacco rod 21 may be about 12 mm, a length of a first segment of the filter rod 22 may be about 10 mm, a length of a second segment of the filter rod 22 may be about 14 mm, and a length of a third segment of the filter rod 22 may be about 12 mm. However, embodiments are not limited thereto.

The cigarette 2 may be wrapped with at least one wrapper 24. The wrapper 24 may have at least one hole through which external air is introduced or internal gas is discharged outside. For example, the cigarette 2 may be wrapped with one wrapper 24. As another example, the cigarette 2 may be wrapped with two or more wrappers 24 in an overlapping manner. For example, the tobacco rod 21 may be wrapped with a first wrapper 241, and the filter rod 22 may be wrapped with wrappers 242, 243, and 244. In addition, the cigarette 2 may be entirely wrapped again with a single wrapper 245. For example, when the filter rod 22 includes a plurality of segments, the plurality of segments may be wrapped with the wrappers 242, 243, and 244, respectively.

The first wrapper 241 and the second wrapper 242 may be formed of general filter wrapping paper. For example, the first wrapper 241 and the second wrapper 242 may be porous wrapping paper or non-porous wrapping paper. In addition, the first wrapper 241 and the second wrapper 242 may be formed of oilproof paper and/or an aluminum laminated wrapping material.

The third wrapper 243 may be formed of hard wrapping paper. For example, the basis weight of the third wrapper 243 may be in a range of 88 g/m² to 96 g/m², and desirably, may be in a range of 90 g/m² to 94 g/m². In addition, the thickness of the third wrapper 243 may be in a range of 120 micrometers (μm) to 130 μm, and desirably, may be 125 μm.

The fourth wrapper 244 may be formed of oilproof hard wrapping paper. For example, the basis weight of the fourth wrapper 244 may be in a range of 88 g/m² to 96 g/m², and desirably, may be in a range of 90 g/m² to 94 g/m². In addition, the thickness of the fourth wrapper 244 may be in a range of 120 μm to 130 μm, and desirably, may be 125 μm.

The fifth wrapper 245 may be formed of sterile paper (e.g., MFW). Here, the sterile paper (MFW) may refer to paper specially prepared such that it has enhanced tensile strength, water resistance, smoothness, or the like, compared to general paper. For example, the basis weight of the fifth wrapper 245 may be in a range of 57 g/m² to 63 g/m², and desirably, may be 60 g/m². In addition, the thickness of the fifth wrapper 245 may be in a range of 64 μm to 70 μm, and desirably, may be 67 μm.

The fifth wrapper 245 may have a predetermined material internally added thereto. The material may be, for example, silicon. However, embodiments are not limited thereto. Silicon may have properties, such as, for example, heat resistance, which is characterized by less change by temperature, oxidation resistance which refers to resistance to oxidation, resistance to various chemicals, water repellency against water, or electrical insulation. However, silicon may not be necessarily used, but any material having such properties described above may be applied to (or used to coat) the fifth wrapper 245 without limitation.

The fifth wrapper 245 may prevent the cigarette 2 from burning. For example, there may be a probability that the cigarette 2 burns when the tobacco rod 21 is heated by the heater 13. For example, when the temperature rises above an ignition point of any one of materials included in the tobacco rod 21, the cigarette 2 may burn. Even in this case, it may still be possible to prevent the cigarette 2 from burning because the fifth wrapper 245 includes a non-combustible material.

In addition, the fifth wrapper 245 may prevent an aerosol generating device (e.g., holder) from being contaminated by substances produced in the cigarette 2. For example, liquid substances may be produced in the cigarette 2 by puffs from a user. For example, as an aerosol generated in the cigarette 2 is cooled by external air, liquid substances (e.g., water, etc.) may be produced. Thus, wrapping the cigarette 2 with the fifth wrapper 245 may prevent the liquid substances produced in the cigarette 2 from leaking out of the cigarette 2.

The tobacco rod 21 may include an aerosol generating material. The aerosol generating material may include, for example, at least one of glycerin, propylene glycol, ethylene glycol, dipropylene glycol, diethylene glycol, triethylene glycol, tetraethylene glycol, or oleyl alcohol. However, embodiments are not limited thereto. The tobacco rod 21 may also include other additives such as, for example, a flavoring agent, a wetting agent, and/or an organic acid. In addition, the tobacco rod 21 may include a flavoring liquid such as menthol or a moisturizing agent that is added as being sprayed onto the tobacco rod 21.

The tobacco rod 21 may be manufactured in various forms. For example, the tobacco rod 21 may be formed as a sheet or a strand. Alternatively, the tobacco rod 21 may be formed of tobacco leaves finely cut from a tobacco sheet. In addition, the tobacco rod 21 may be enveloped by a thermally conductive material. The thermally conductive material may be, for example, a metal foil such as aluminum foil. However, embodiments are not limited thereto. For example, the thermally conductive material enveloping the tobacco rod 21 may evenly distribute the heat transferred to the tobacco rod 21 to improve the conductivity of the heat to be applied to the tobacco rod 21, thereby improving the taste of tobacco. In addition, the thermally conductive material enveloping the tobacco rod 21 may function as a susceptor heated by an inductive heater. In this case, although not shown, the tobacco rod 21 may further include an additional susceptor in addition to the thermally conductive material enveloping the outside thereof.

The filter rod 22 may be a cellulose acetate filter. However, there is no limit to the shape of the filter rod 22. For example, the filter rod 22 may be a cylindrical rod, or a tubular rod including a hollow therein. The filter rod 22 may also be a recess-type rod. For example, when the filter rod 22 includes a plurality of segments, at least one of the segments may be manufactured in a different shape.

A first segment of the filter rod 22 may be a cellulose acetate filter. For example, the first segment may be a tubular structure including a hollow therein. The first segment may prevent internal materials of the tobacco rod 21 from being pushed back when the heater 13 is inserted into the tobacco rod 21 and may cool the aerosol. A desirable diameter of the hollow included in the first segment may be adopted from a range of 2 mm to 4.5 mm. However, embodiments are not limited thereto.

A desirable length of the first segment may be adopted from a range of 4 mm to 30 mm. However, embodiments are not limited thereto. Desirably, the length of the first segment may be 10 mm. However, embodiments are not limited thereto.

The first segment may have a hardness that is adjustable through an adjustment of the content of a plasticizer in the process of manufacturing the first segment. In addition, the first segment may be manufactured by inserting a structure such as a film or a tube of the same or different materials therein (e.g., in the hollow).

A second segment of the filter rod 22 may cool an aerosol generated as the heater 13 heats the tobacco rod 21. The user may thus inhale the aerosol cooled down to a suitable temperature.

A length or diameter of the second segment may be determined in various ways according to the shape of the cigarette 2. For example, a desirable length of the second segment may be adopted from a range of 7 mm to 20 mm. Desirably, the length of the second segment may be about 14 mm. However, embodiments are not limited thereto.

The second segment may be manufactured by weaving a polymer fiber. In this case, a flavoring liquid may be applied to a fiber formed of a polymer. As another example, the second segment may be manufactured by weaving a separate fiber, to which a flavoring liquid is applied, and the fiber formed of the polymer together. As still another example, the second segment may be formed with a crimped polymer sheet.

For example, the polymer may be prepared with a material selected from the group consisting of polyethylene (PE), polypropylene (PP), polyvinyl chloride (PVC), polyethylene terephthalate (PET), polylactic acid (PLA), cellulose acetate (CA), and aluminum foil.

As the second segment is formed with the woven polymer fiber or the crimped polymer sheet, the second segment may include a single channel or a plurality of channels extending in a longitudinal direction. A channel used herein may refer to a path through which a gas (e.g., air or aerosol) passes.

For example, the second segment formed with the crimped polymer sheet may be formed of a material having a thickness between about 5 μm and about 300 μm, for example, between about 10 μm and about 250 μm. In addition, the total surface area of the second segment may be between about 300 mm²/mm and about 1000 mm²/mm. Further, an aerosol cooling element may be formed from a material having a specific surface area between about 10 mm²/mg and about 100 mm²/mg.

The second segment may include a thread containing a volatile flavor ingredient. The volatile flavor ingredient may be menthol. However, embodiments are not limited thereto. For example, the thread may be filled with an amount of menthol sufficient to provide at least 1.5 mg of menthol to the second segment.

A third segment of the filter rod 22 may be a cellulose acetate filter. A desirable length of the third segment may be adopted from a range of 4 mm to 20 mm. For example, the length of the third segment may be about 12 mm. However, embodiments are not limited thereto.

The third segment may be manufactured such that a flavor is generated by spraying a flavoring liquid onto the third segment in the process of manufacturing the third segment. Alternatively, a separate fiber to which the flavoring liquid is applied may be inserted into the third segment. An aerosol generated in the tobacco rod 21 may be cooled as it passes through the second segment of the filter rod 22, and the cooled aerosol may pass through the third segment into the user. Accordingly, when a flavoring element is added to the third segment, the flavor carried to the user may last much longer.

In addition, the filter rod 22 may include at least one capsule 23. Here, the capsule 23 may perform a function of generating a flavor or a function of generating an aerosol. For example, the capsule 23 may have a structure in which a liquid containing a fragrance is wrapped with a film. The capsule 23 may have a spherical or cylindrical shape. However, embodiments are not limited thereto.

Referring to FIG. 5, a cigarette 3 may further include a front end plug 33. The front end plug 33 may be disposed on one side of a tobacco rod 31 opposite to a filter rod 32. The front end plug 33 may prevent the tobacco rod 31 from escaping to the outside, and may also prevent an aerosol liquefied in the tobacco rod 31 during smoking from flowing into an aerosol generating device (e.g., the aerosol generating device 1 of FIGS. 1 to 3).

The filter rod 32 may include a first segment 321 and a second segment 322. Here, the first segment 321 may correspond to the first segment of the filter rod 22 of FIG. 4, and the second segment 322 may correspond to the third segment of the filter rod 22 of FIG. 4.

A diameter and a total length of the cigarette 3 may correspond to the diameter and the total length of the cigarette 2 of FIG. 4. For example, a length of the front end plug 33 may be about 7 mm, a length of the tobacco rod 31 may be about 15 mm, a length of the first segment 321 may be about 12 mm, and a length of the second segment 322 may be about 14 mm. However, embodiments are not limited thereto.

The cigarette 3 may be wrapped with at least one wrapper 35. The wrapper 35 may have at least one hole through which external air is introduced or internal gas flows out. For example, the front end plug 33 may be wrapped with a first wrapper 351, the tobacco rod 31 may be wrapped with a second wrapper 352, the first segment 321 may be wrapped with a third wrapper 353, and the second segment 322 may be wrapped with a fourth wrapper 354. In addition, the cigarette 3 may be entirely wrapped again with a fifth wrapper 355.

In addition, at least one perforation 36 may be formed in the fifth wrapper 355. For example, the perforation 36 may be formed in a region surrounding the tobacco rod 31. However, embodiments are not limited thereto. The perforation 36 may perform a function of transferring heat generated by the heater 13 shown in FIGS. 2 and 3 to the inside of the tobacco rod 31.

In addition, the second segment 322 may include at least one capsule 34. Here, the capsule 34 may perform a function of generating a flavor or a function of generating an aerosol. For example, the capsule 34 may have a structure in which a liquid containing a fragrance is wrapped with a film. The capsule 34 may have a spherical or cylindrical shape. However, embodiments are not limited thereto.

The first wrapper 351 may be a combination of general filter wrapping paper and a metal foil such as aluminum foil. For example, a total thickness of the first wrapper 351 may be in a range of 45 μm to 55 μm, and desirably, may be about 50.3 μm. Further, a thickness of the metal foil of the first wrapper 351 may be in a range of 6 μm to 7 μm, and desirably, may be 6.3 μm. In addition, the basis weight of the first wrapper 351 may be in a range of 50 g/m² to 55 g/m², and desirably, may be 53 g/m².

The second wrapper 352 and the third wrapper 353 may be formed with general filter wrapping paper. For example, the second wrapper 352 and the third wrapper 353 may be porous wrapping paper or non-porous wrapping paper.

For example, the porosity of the second wrapper 352 may be 35000 CU. However, embodiments are not limited thereto. Further, a thickness of the second wrapper 352 may be in a range of 70 μm to 80 μm, and desirably, may be 78 μm. In addition, the basis weight of the second wrapper 352 may be in a range of 20 g/m² to 25 g/m², and desirably, may be 23.5 g/m².

For example, the porosity of the third wrapper 353 may be 24000 CU. However, embodiments are not limited thereto. Further, a thickness of the third wrapper 353 may be in a range of 60 μm to 70 μm, and desirably, may be 68 μm. In addition, the basis weight of the third wrapper 353 may be in a range of 20 g/m² to 25 g/m², and desirably, may be 21 g/m².

The fourth wrapper 354 may be formed with polylactic acid (PLA) laminated paper. Here, the PLA laminated paper may refer to three-ply paper including a paper layer, a PLA layer, and another paper layer. For example, a thickness of the fourth wrapper 354 may be in a range of 100 μm to 120 μm, and desirably, may be 110 μm. In addition, the basis weight of the fourth wrapper 354 may be in a range of 80 g/m² to 100 g/m², and desirably, may be 88 g/m².

The fifth wrapper 355 may be formed of sterile paper (e.g., MFW). Here, the sterile paper (MFW) may refer to paper specially prepared such that it has enhanced tensile strength, water resistance, smoothness, or the like, compared to general paper. For example, the basis weight of the fifth wrapper 355 may be in a range of 57 g/m² to 63 g/m², and desirably, may be 60 g/m². Further, the thickness of the fifth wrapper 355 may be in a range of 64 μm to 70 μm, and desirably, may be 67 μm.

The fifth wrapper 355 may have a predetermined material internally added thereto. The material may be, for example, silicon. However, embodiments are not limited thereto. Silicon may have properties, such as, for example, heat resistance, which is characterized by less change by temperature, oxidation resistance which refers to resistance to oxidation, resistance to various chemicals, water repellency against water, or electrical insulation. However, silicon may not be necessarily used, but any material having such properties described above may be applied to (or used to coat) the fifth wrapper 355 without limitation.

The front end plug 33 may be formed of cellulose acetate. For example, the front end plug 33 may be manufactured by adding a plasticizer (e.g., triacetin) to cellulose acetate tow. A mono denier of a filament of the cellulose acetate tow may be in a range of 1.0 to 10.0, and desirably, may be in a range of 4.0 to 6.0. The mono denier of the filament of the front end plug 33 may be more desirably 5.0. In addition, a cross section of the filament of the front end plug 33 may be Y-shaped. A total denier of the front end plug 33 may be in a range of 20000 to 30000, and desirably, may be in a range of 25000 to 30000. The total denier of the front end plug 33 may be more desirably 28000.

In addition, as needed, the front end plug 33 may include at least one channel, and a cross-sectional shape of the channel may be provided in various ways.

The tobacco rod 31 may correspond to the tobacco rod 21 described above with reference to FIG. 4. Thus, a detailed description of the tobacco rod 31 will be omitted here.

The first segment 321 may be formed of cellulose acetate. For example, the first segment may be a tubular structure including a hollow therein. The first segment 321 may be manufactured by adding a plasticizer (e.g., triacetin) to cellulose acetate tow. For example, a mono denier and a total denier of the first segment 321 may be the same as the mono denier and the total denier of the front end plug 33.

The second segment 322 may be formed of cellulose acetate. A mono denier of a filament of the second segment 322 may be in a range of 1.0 to 10.0, and desirably, may be in a range of 8.0 to 10.0. The mono denier of the filament of the second segment 322 may be more desirably 9.0. In addition, a cross section of the filament of the second segment 322 may be Y-shaped. A total denier of the second segment 322 may be in a range of 20000 to 30000, and desirably, may be 25000.

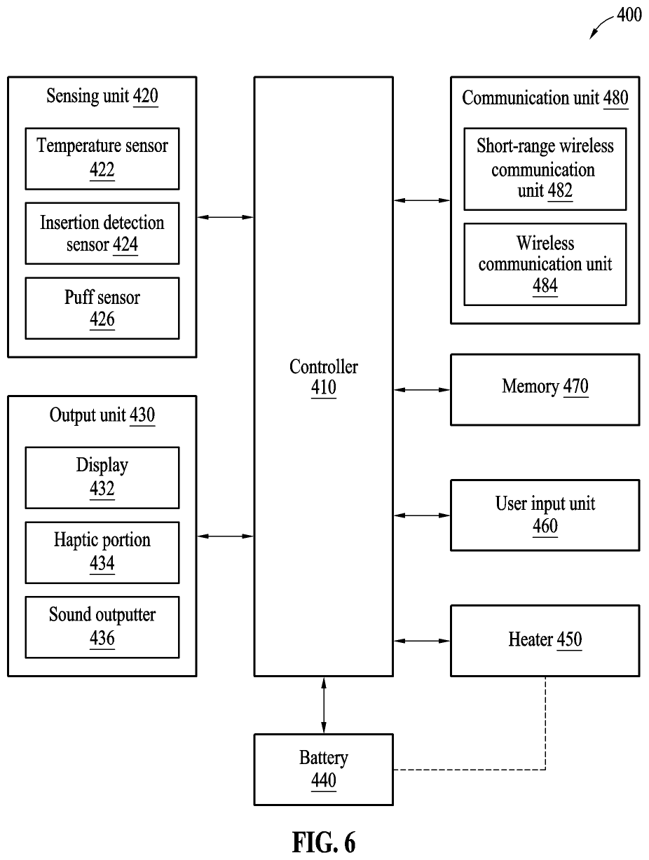

FIG. 6 is a block diagram illustrating an aerosol generating device 400 according to an embodiment.

The aerosol generating device 400 may include a controller 410, a sensing unit 420, an output unit 430, a battery 440, a heater 450, a user input unit 460, a memory 470, and a communication unit 480. However, the internal structure of the aerosol generating device 400 is not limited to what is shown in FIG. 6. It is to be understood by one of ordinary skill in the art to which the disclosure pertains that some of the components shown in FIG. 6 may be omitted or new components may be added according to the design of the aerosol generating device 400.

The sensing unit 420 may sense a state of the aerosol generating device 400 or a state of an environment around the aerosol generating device 400, and transmit sensing information obtained through the sensing to the controller 410. Based on the sensing information, the controller 410 may control the aerosol generating device 400 to control operations of the heater 450, restrict smoking, determine whether an aerosol generating article (e.g., a cigarette, a cartridge, etc.) is inserted, display a notification, and perform other functions.

The sensing unit 420 may include at least one of a temperature sensor 422, an insertion detection sensor 424, or a puff sensor 426. However, embodiments are not limited thereto.

The temperature sensor 422 may sense a temperature at which the heater 450 (or an aerosol generating material) is heated. The aerosol generating device 400 may include a separate temperature sensor for sensing the temperature of the heater 450, or the heater 450 itself may perform a function as a temperature sensor. Alternatively, the temperature sensor 422 may be arranged around the battery 440 to monitor the temperature of the battery 440.

The insertion detection sensor 424 may sense whether the aerosol generating article is inserted and/or removed. The insertion detection sensor 424 may include, for example, at least one of a film sensor, a pressure sensor, a light sensor, a resistive sensor, a capacitive sensor, an inductive sensor, or an infrared sensor, which may sense a signal change by the insertion and/or removal of the aerosol generating article.

The puff sensor 426 may sense a puff from a user based on various physical changes in an airflow path or airflow channel. For example, the puff sensor 426 may sense the puff from the user based on any one of a temperature change, a flow change, a voltage change, and a pressure change.

The sensing unit 420 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 422 to 426 described above. A function of each sensor may be intuitively inferable from its name by one of ordinary skill in the art, and thus, a more detailed description thereof will be omitted here.

The output unit 430 may output information about the state of the aerosol generating device 400 and provide the information to the user. The output unit 430 may include at least one of a display 432, a haptic portion 434, or a sound outputter 436. However, embodiments are not limited thereto. When the display 432 and a touchpad are provided in a layered structure to form a touchscreen, the display 432 may be used as an input device in addition to an output device.

The display 432 may visually provide information about the aerosol generating device 400 to the user. The information about the aerosol generating device 400 may include, for example, a charging/discharging state of the battery 440 of the aerosol generating device 400, a preheating state of the heater 450, an insertion/removal state of the aerosol generating article, a limited usage state (e.g., an abnormal article detected) of the aerosol generating device 400, or the like, and the display 432 may externally output the information. The display 432 may be, for example, a liquid-crystal display panel (LCD), an organic light-emitting display panel (OLED), or the like. The display 432 may also be in the form of a light-emitting diode (LED) device.

The haptic portion 434 may provide information about the aerosol generating device 400 to the user in a haptic way by converting an electrical signal into a mechanical stimulus or an electrical stimulus. The haptic portion 434 may include, for example, a motor, a piezoelectric element, or an electrical stimulation device.

The sound outputter 436 may provide information about the aerosol generating device 400 to the user in an auditory way. For example, the sound outputter 436 may convert an electrical signal into a sound signal and externally output the sound signal.

The battery 440 may supply power to be used to operate the aerosol generating device 400. The battery 440 may supply power to heat the heater 450. In addition, the battery 440 may supply power required for operations of the other components (e.g., the sensing unit 420, the output unit 430, the user input unit 460, the memory 470, and the communication unit 480) included in the aerosol generating device 400. The battery 440 may be a rechargeable battery or a disposable battery. The battery 440 may be, for example, a lithium polymer (LiPoly) battery. However, embodiments are not limited thereto.

The heater 450 may receive power from the battery 440 to heat the aerosol generating material. Although not shown in FIG. 6, the aerosol generating device 400 may further include a power conversion circuit (e.g., a direct current (DC)-to-DC (DC/DC) converter) that converts power of the battery 440 and supplies the power to the heater 450. In addition, when the aerosol generating device 400 generates an aerosol in an induction heating manner, the aerosol generating device 400 may further include a DC-to-alternating current (AC) (DC/AC) converter that converts DC power of the battery 440 into AC power.

The controller 410, the sensing unit 420, the output unit 430, the user input unit 460, the memory 470, and the communication unit 480 may receive power from the battery 440 to perform functions. Although not shown in FIG. 6, the aerosol generating device 400 may further include a power conversion circuit, for example, a low dropout (LDO) circuit or a voltage regulator circuit, that converts the power of the battery 440 and supplies the power to respective components.

In an embodiment, the heater 450 may be formed of any suitable electrically resistive material. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 450 may be implemented as a metal heating wire, a metal heating plate on which an electrically conductive track is arranged, a ceramic heating structure, or the like, but is not limited thereto.

In an embodiment, the heater 450 may be an induction heater. For example, the heater 450 may include a susceptor that heats the aerosol generating material by generating heat through a magnetic field applied by a coil.

In an embodiment, the heater 450 may include a plurality of heaters. For example, the heater 450 may include a first heater for heating a cigarette and a second heater for heating a liquid.

The user input unit 460 may receive information input from the user or may output information to the user. For example, the user input unit 460 may include a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. In addition, although not shown in FIG. 6, the aerosol generating device 400 may further include a connection interface such as a universal serial bus (USB) interface, and may be connected to another external device through the connection interface such as a USB interface to transmit and receive information or to charge the battery 440.

The memory 470, which is hardware for storing various pieces of data processed in the aerosol generating device 400, may store data processed by the controller 410 and data to be processed by the controller 410. The memory 470 may include at least one type of storage medium of a flash memory type memory, a hard disk type memory, a multimedia card micro type memory, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 470 may store an operating time of the aerosol generating device 400, a maximum number of puffs, a current number of puffs, at least one temperature profile, data associated with a smoking pattern of the user, or the like.

The communication unit 480 may include at least one component for communicating with another electronic device. For example, the communication unit 480 may include a short-range wireless communication unit 482 and a wireless communication unit 484.

The short-range wireless communication unit 482 may include a Bluetooth communication unit, a Bluetooth low energy (BLE) communication unit, a near field communication unit, a wireless local area network (WLAN) wireless fidelity (Wi-Fi) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

The wireless communication unit 484 may include, for example, a cellular network communication unit, an Internet communication unit, a computer network (e.g., a LAN or a wide-area network (WAN)) communication unit, or the like. However, embodiments are not limited thereto. The wireless communication unit 484 may use subscriber information (e.g., international mobile subscriber identity (IMSI)) to identify and authenticate the aerosol generating device 400 in a communication network.

The controller 410 may control the overall operation of the aerosol generating device 400. In an embodiment, the controller 410 may include at least one processor. The processor may be implemented as an array of a plurality of logic gates, or may be implemented as a combination of a general-purpose microprocessor and a memory in which a program executable in the microprocessor is stored. In addition, it is to be understood by one of ordinary skill in the art to which the disclosure pertains that it may be implemented in other types of hardware.

The controller 410 may control the temperature of the heater 450 by controlling the supply of power from the battery 440 to the heater 450. For example, the controller 410 may control the supply of power by controlling the switching of a switching element between the battery 440 and the heater 450. As another example, a direct heating circuit may control the supply of power to the heater 450 according to a control command from the controller 410.

The controller 410 may analyze a sensing result obtained by the sensing of the sensing unit 420 and control processes to be performed thereafter. For example, the controller 410 may control power to be supplied to the heater 450 to start or end an operation of the heater 450 based on the sensing result obtained by the sensing unit 420. As another example, the controller 410 may control an amount of power to be supplied to the heater 450 and a time for which the power is to be supplied, such that the heater 450 may be heated up to a predetermined temperature or maintained at a desired temperature, based on the sensing result obtained by the sensing unit 420.

The controller 410 may control the output unit 430 based on the sensing result obtained by the sensing unit 420. For example, when the number of puffs counted through the puff sensor 426 reaches a preset number, the controller 410 may inform the user that the aerosol generating device 400 is ending soon, through at least one of the display 432, the haptic portion 434, or the sound outputter 436.

In an embodiment, the controller 410 may control a power supply time and/or a power supply amount for the heater 450 according to a state of the aerosol generating article sensed by the sensing unit 420. For example, when the aerosol generating article is in an over-humidified state, the controller 410 may control the power supply time for an inductive coil to increase a preheating time, compared to a case where the aerosol generating article is in a general state.

One embodiment may also be implemented in the form of a recording medium including instructions executable by a computer, such as a program module executable by the computer. A computer-readable medium may be any available medium that may be accessed by a computer and includes a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

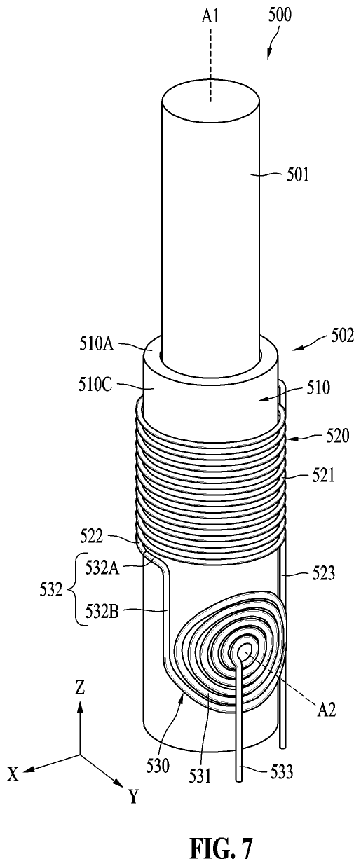

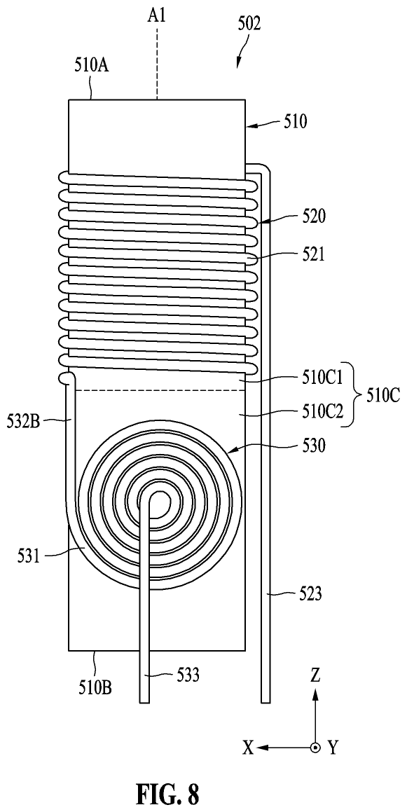

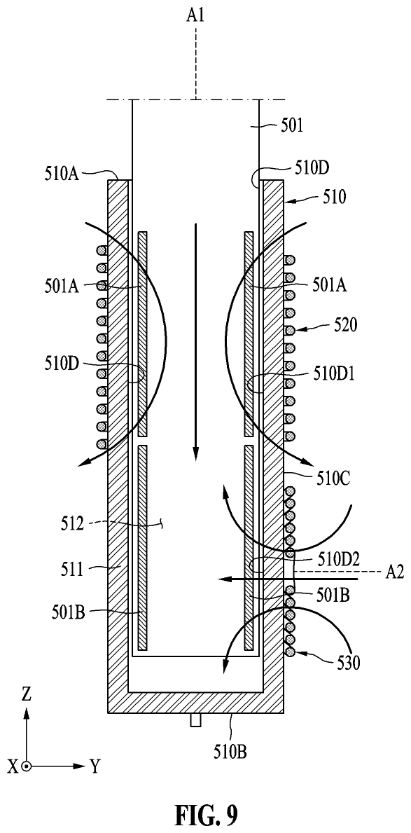

FIG. 7 is a perspective view illustrating a heating structure for heating an aerosol generating article according to an embodiment, FIG. 8 is a side view illustrating a heating structure according to an embodiment, and FIG. 9 is a cross-sectional view illustrating a heating structure according to an embodiment.

Referring to FIGS. 7 to 9, an aerosol generating system 500 may include an aerosol generating article 501 (e.g., the cigarette 2) and a heating structure 502 (e.g., the heater 13, 450) configured to heat the aerosol generating article 501.

The aerosol generating article 501 may include a plurality of susceptors 501A and 501B. For example, the aerosol generating article 501 may include at least one first susceptor 501A positioned relatively downstream, and at least one second susceptor 501B positioned relatively upstream.

The heating structure 502 may include a heating housing 510 configured to heat the aerosol generating article 501.

The heating housing 510 may include a body portion 511 having a first surface 510A (e.g., a first end surface or an upper end surface), a second surface 510B (e.g., a second end surface or a lower end surface) opposite to the first surface 510A, an outer side surface 510C between the first surface 510A and the second surface 510B, and an inner side surface 510D between the first surface 510A and the second surface 510B. The first surface 510A may form an at least partially open surface, while the second surface 510B may form an at least partially closed surface. The outer side surface 510C may include a first outer region 510C1 (e.g., an upper outer region) connected to the first surface 510A, and a second outer region 510C2 (e.g., a lower outer region) connected to the second surface 510B. The inner side surface 510D may include a first inner region 510D1 (e.g., an upper inner region) connected to the first surface 510A, and a second inner region 510D2 (e.g., a lower inner region) connected to the second surface 510B.

The heating housing 510 may include a hollow portion 512 defined by the inner side surface 510D. The hollow portion 512 may be configured to at least partially accommodate the aerosol generating article 501.

The heating structure 502 may include a plurality of coils 520 and 530 configured to generate magnetic fields in different directions, respectively. In an embodiment, the heating structure 502 may include a first coil 520 configured to generate a magnetic field substantially in a first direction (e.g., a −Z direction), and a second coil 530 configured to generate a magnetic field substantially in a second direction (e.g., a −Y direction) intersecting with (e.g., orthogonal to) the first direction.

The first coil 520 may be configured to be magnetically coupled to the first susceptor 501A. The first coil 520 may include a first winding portion 521 that has a first axis A1 (e.g., a +Z axis), at least partially surrounds the outer side surface 510C, and winds in a first helical direction (e.g., a clockwise direction) on the first axis A1. Here, the first axis A1 may also be defined as an axis in a longitudinal direction of the body portion 511. In an embodiment, the first winding portion 521 may be positioned in the first outer region 510C1.

In an embodiment, the first coil 520 may include a first connecting portion 522 forming a first end portion (e.g., a lower end portion) of the first winding portion 521. The first connecting portion 522 may be electrically connected to the second coil 530. In an embodiment, the first connecting portion 522 may be positioned in the first outer region 510C1. In some embodiments, the first connecting portion 522 may at least partially surround the first outer region 510C1 with respect to the first axis A1.

In an embodiment, the first coil 520 may include a second connecting portion 523 forming a second end portion (e.g., an upper end portion) opposite to the first end portion of the first winding portion 521. The second connecting portion 523 may be electrically connected to a controller (e.g., the controller 12, 410) of an aerosol generating device (e.g., the aerosol generating device 1, 400). In an embodiment, the second connecting portion 523 may traverse the first winding portion 521 and extend in a direction opposite to an axial direction (e.g., a +Z direction) of the first axis A1 while being spaced apart from the outer side surface 510C.

The second coil 530 may be configured to be magnetically coupled to the second susceptor 501B. The second coil 530 may include a second winding portion 531 that has a second axis A2 (e.g., a +Y axis) intersecting with (e.g., orthogonal to) the first axis A1, is positioned on the outer side surface 510C, and winds in a second helical direction (e.g., a clockwise direction) on the second axis A2. Here, the second axis A2 may be defined as a normal direction of the outer side surface 510C or a radial direction of the body portion 511. In an embodiment, the second winding portion 531 may be positioned in the second outer region 510C2.

In an embodiment, the second coil 530 may include a third connecting portion 532 forming a first end portion (e.g., a left end portion) of the second winding portion 531. The third connecting portion 532 may be electrically connected to the first coil 520. In an embodiment, the third connecting portion 532 may include a first portion 532A physically and electrically connected to the first connecting portion 522, and a second portion 532B physically and electrically connected to the first portion 532A and the second winding portion 531. In some embodiments, the first portion 532A may be positioned in the first outer region 510C1 while at least partially surrounding the first outer region 510C1 with respect to the first axis A1, and the second portion 532B may extend on the second outer region 510C2 in the axial direction of the first axis A1 and extend on the first outer region 510C1 while at least partially bending.

In an embodiment, the second coil 530 may include a fourth connecting portion 533 forming a second end portion (e.g., a central end portion) of the second winding portion 531. The fourth connecting portion 533 may be electrically connected to the controller (e.g., the controller 12, 410) of the aerosol generating device (e.g., the aerosol generating device 1, 400). In an embodiment, the fourth connecting portion 533 may at least partially traverse the second winding portion 531 and extend in the direction opposite to the axial direction (e.g., the +Z direction) of the first axis A1 while being spaced apart from the outer side surface 510C. In some embodiments, the fourth connecting portion 533 may run substantially parallel to the second connecting portion 523.

In an embodiment, the first coil 520 and the second coil 530 may not be directly connected on the outer side surface 510C. For example, the first coil 520 may not include the first connecting portion 522, and the second coil 530 may not include the third connecting portion 532.

In some embodiments, the heating structure 502 may include a third coil (not shown) configured to generate a magnetic field in a direction (e.g., a −X direction) intersecting with (e.g., orthogonal to) each of the direction in which the first coil 520 generates the magnetic field and the direction in which the second coil 530 generates the magnetic field. The third coil may be configured to be magnetically coupled to the second susceptor 501B. The third coil may include a third winding portion that winds in a third helical direction (e.g., a clockwise direction) with respect to a third axis intersecting with (e.g., orthogonal to) each of the first axis and the second axis.

In an embodiment, the third coil may include a fifth connecting portion physically and electrically connected to the first winding portion 521 and/or the second winding portion 531. In an embodiment, the third coil may not include the fifth connecting portion.

In an embodiment, the third coil may include a sixth connecting portion electrically connected to the controller (e.g., the controller 12, 410) of the aerosol generating device (e.g., the aerosol generating device 1, 400).

The embodiments of the disclosure are intended to be illustrative and not restrictive. Various modifications may be made to the detailed description of the disclosure including the accompanying scope of claims and equivalents. Any of the embodiment(s) described herein may be used in combination with any other embodiment(s) described herein.

1. A heating structure comprising:
a heating housing comprising a body portion, the body portion comprising a first surface, a second surface opposite to the first surface, and a side surface between the first surface and the second surface, and a hollow portion defined by the side surface;
a first coil having a first axis in a first direction between the first surface and the second surface of the body portion; and
a second coil having a second axis in a second direction intersecting with the first direction of the body portion.

2. The heating structure of claim 1, wherein the first direction is a longitudinal direction from the second surface to the first surface, and the second direction is a normal direction of the side surface of the body portion.

3. The heating structure of claim 2, wherein the first coil is wound in a clockwise direction on the first axis, and the second coil is wound in a clockwise direction on the second axis.

4. The heating structure of claim 1, wherein the first coil and the second coil are directly connected on the side surface of the body portion.

5. The heating structure of claim 1, wherein the first coil and the second coil are separated on the side surface of the body portion.

6. The heating structure of claim 1, wherein the first coil is positioned in a first region of the body portion, and the second coil is positioned in a second region different from the first region of the body portion.

7. The heating structure of claim 6, wherein the first region is a region adjacent to the first surface, and the second region is a region adjacent to the second surface.

8. The heating structure of claim 1, further comprising:
a third coil having a third axis in a third direction intersecting with each of the first direction and the second direction of the body portion.

9. The heating structure of claim 8, wherein the third direction is a normal direction of the side surface of the body portion.

10. The heating structure of claim 9, wherein the third coil is wound in a clockwise direction on the third axis.

11. An aerosol generating device comprising:
a housing configured to accommodate an aerosol generating article; and
a heating structure configured to heat the aerosol generating article positioned and accommodated in the housing,
wherein the heating structure comprises:
a heating housing comprising a body portion, the body portion comprising a first surface, a second surface opposite to the first surface, and a side surface between the first surface and the second surface, and a hollow portion defined by the side surface;
a first coil having a first axis in a first direction between the first surface and the second surface of the body portion; and
a second coil having a second axis in a second direction intersecting with the first direction of the body portion.

12. The aerosol generating device of claim 11, wherein the first coil and the second coil are directly connected on the side surface of the body portion.

13. The aerosol generating device of claim 11, wherein the first coil and the second coil are separated on the side surface of the body portion.

14. The aerosol generating device of claim 11, wherein the heating structure further comprises a third coil having a third axis in a third direction intersecting with each of the first direction and the second direction of the body portion.

15. An aerosol generating system comprising:
an aerosol generating article comprising an aerosol generating material and a susceptor; and
an aerosol generating device comprising a housing configured to accommodate the aerosol generating article and a heating structure configured to heat the aerosol generating article positioned and accommodated in the housing,
wherein the heating structure comprises:
a heating housing comprising a body portion, the body portion comprising a first surface, a second surface opposite to the first surface, and a side surface between the first surface and the second surface, and a hollow portion defined by the side surface;
a first coil having a first axis in a first direction between the first surface and the second surface of the body portion; and
a second coil having a second axis in a second direction intersecting with the first direction of the body portion.
